(19) United States
(12) Patent Application Publication
(10) Pub. No.: US 2024/0427199 A1
(43) Pub. Date: Dec. 26, 2024

(54) OPTICAL CONTROL ELEMENT

(71) Applicant: Japan Display Inc., Tokyo (JP)

(72) Inventor: Toshiharu MATSUSHIMA, Tokyo (JP)

(73) Assignee: Japan Display Inc., Tokyo (JP)

(21) Appl. No.: 18/750,122

(22) Filed: Jun. 21, 2024

(30) Foreign Application Priority Data
Jun. 23, 2023 (JP) 2023-103236

(51) Int. Cl. G02F 1/1343; G02F 1/1333; G02F 1/1337

(52) U.S. Cl. CPC G02F 1/134309; G02F 1/133345; G02F 1/1337; G02F 1/13439

(57) ABSTRACT

According to one embodiment, an optical control element includes a base, an electrode provided on the base, a liquid crystal layer provided on the electrode, and a high-resistance layer having a resistance higher than that of the electrode and provided between the electrode and the liquid crystal layer, wherein the electrode overlaps the high-resistance layer in plan view, and a connection portion of the high resistance layer is in contact with the electrode.

### CROSS-REFERENCE TO RELATED APPLICATIONS

This application is based upon and claims the benefit of priority from Japanese Patent Application No. 2023-103236, filed Jun. 23, 2023, the entire contents of which are incorporated herein by reference.

### FIELD

Embodiments described herein relate generally to an optical control element.

### BACKGROUND

Liquid crystal elements which can modulate liquid crystals by a voltage applied between electrodes and obtain a lens function have been developed.

### BRIEF DESCRIPTION OF THE DRAWINGS

FIG. 1 is a cross-sectional view schematically showing a configuration example of an optical control element of an embodiment.

FIG. 2 is a plan view schematically showing a configuration example of the optical control element of the embodiment.

FIG. 3 is a plan view schematically showing a configuration example of the optical control element of the embodiment.

FIG. 4 is a plan view showing a shape and arrangement of a high-resistance layer in the case of forming a Fresnel lens.

FIG. 5 is a plan view showing a shape and arrangement of electrodes opposing an outermost high-resistance layer of the circular ring-shaped (annular-shaped) high-resistance layer shown in FIG. 4.

FIG. 6 is a plan view showing a shape and arrangement of connection portions provided in the respective electrodes shown in FIG. 5.

FIG. 7 is an enlarged view of an area enclosed by a dotted line in FIG. 6.

FIG. 8 is a plan view showing a shape and arrangement of electrodes opposing an innermost high-resistance layer of the circular ring-shaped (annular-shaped) high-resistance layer shown in FIG. 4.

FIG. 9 is a plan view showing a cross-sectional view of an optical control element of a comparative example 1.

FIG. 10 is a diagram showing the relationship between a distance between the electrodes and a voltage in the optical control element shown in FIG. 9.

FIG. 11 is a plan view showing a cross-sectional view of an optical control element of a comparative example 2.

FIG. 12 is a diagram showing the relationship between a distance between the electrodes and a voltage in the optical control element shown in FIG. 11.

FIG. 13 is a diagram showing the relationship between a distance between the electrodes and a voltage in the optical control element of the embodiment.

FIG. 14 is a diagram showing the distribution of voltage in the comparative example 1, the comparative example 2, and the embodiment when they are the same as each other in the resistance of the high-resistance layer.

FIG. 15 is a diagram showing the distribution of voltage in the comparative example 2, and the embodiment when they are the same as each other in the resistance of the high-resistance layer.

### DETAILED DESCRIPTION

In general, according to one embodiment, an optical control element comprises
a base;
an electrode provided on the base;
a liquid crystal layer provided on the electrode; and
a high-resistance layer having a resistance higher than that of the electrode and provided between the electrode and the liquid crystal layer, wherein the electrode overlaps the high-resistance layer in plan view, and a connection portion of the high resistance layer is in contact with the electrode.

An object of this embodiment is to provide an optical control element with improved quality.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of an optical control element with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the optical control element in the X-Z plane defined by the first direction X and the third direction Z or in the Y-Z plane defined by the second direction Y and the third direction Z is referred to as cross-sectional view.

### Embodiment

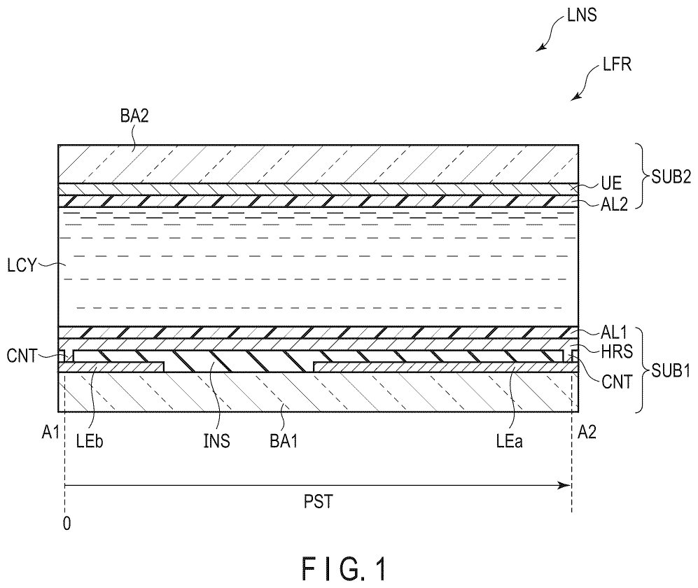

FIG. 1 is a cross-sectional view schematically showing a configuration example of an optical control element of an embodiment. The optical control element LNS of the embodiment includes a plurality of lens forming regions LFR. The example shown in FIG. 1 illustrates a cross-sectional shape of one lens forming region LFR.

The lens forming region LFR comprises a substrate SUB1, a substrate SUB2, and a liquid crystal layer LCY. The substrate SUB1 comprises a base BA1, an electrode LEa, an electrode LEb, an insulating layer INS, a high-resistance layer HRS, and an alignment film AL1. The substrate SUB2 comprises a base BA2, an electrode UE, and an alignment film AL2. The liquid crystal layer LCY is provided between the substrate SUB1 and the substrate SUB2.

When the electrode LEa and the electrode LEb are not distinguished from each other, they are simply referred to as electrodes LE. As will be described in detail later, the electrode LE includes a connection portion CNT brought into contact with the high-resistance layer HRS via a contact hole in the insulating layer INS. For the sake of clarity of explanation, FIG. 1 illustrates that only one of the connection portions CNT of the respective electrodes LEa and LEb on the base BAL is in contact with the high-resistance layer HRS. But, the number of connection portions CNT in contact with the high-resistance layer HRS is not limited to that of this case. Further, the number of electrodes LE is also not limited to two, but may be three or more. The number of high-resistance layers HRS may be one or more.

In the substrate SUB1, the electrode LEa and the electrode LEb are provided on the base BA1. The insulating layer INS covers the base BAL and also the electrode LEa and the electrode LEb. The high-resistance layer HRS is provided on the insulating layer INS. That is, the insulating layer INS is provided between the electrode Lea, and the electrode LEb and the high-resistance layer HRS. The alignment film AL1 is provided on the high-resistance layer HRS. The connection portions CNT of the high-resistance layer HRS are connected to the electrode LEa and the electrodes LEb, respectively, via respective contact holes formed in the insulating layer INS.

In the substrate SUB2, the electrodes UE are provided to be in contact with the base BA2. The alignment film AL2 is provided to be in contact with the electrodes UE. The liquid crystal layer LCY is disposed between the alignment film AL1 of the substrate SUB1 and the alignment film AL2 of the substrate SUB2. That is, the alignment film AL1 and the alignment film AL2 are each in contact with the liquid crystal layer LCY.

Note that it suffices if the electrode LEa and the electrode LEb are each formed from a transparent conductive layer, for example, of indium zinc oxide (ITO). It suffices if the high-resistance layer HRS is formed from a conductive layer having a resistance higher than that of the electrodes LEa and LEb, for example, of indium gallium zinc oxide (IGZO). The insulating layer INS is an insulating layer containing silicon, that is, for example, a silicon oxide layer or a silicon nitride layer.

The optical control element LNS shown in FIG. 1 modulates the liquid crystal layer LCY by the voltage applied between the electrode LEa and the electrode LEb, and the electrode UE, and forms a lens. That is, the optical control element LNS is a liquid crystal lens. In the embodiment, the electrode LEa, the electrode LEb, the electrode UE, and the liquid crystal layer LCY are referred to as a lens forming region LFR. FIG. 1 shows only one lens formation region LFR, but the optical control element LNS comprises a plurality of lens formation regions LFR. By combining the liquid crystal lens with a display panel, for example, a liquid crystal display panel, it is possible to realize a display device which can adjust the light emitted from the pixels of the display panel.

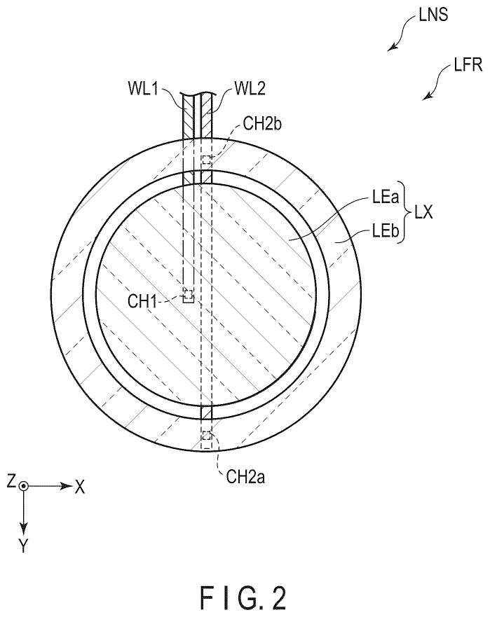

FIG. 2 is a plan view schematically showing a configuration example of the optical control element of the embodiment. The optical control element LNS shown in FIG. 2 comprises a circularly shaped electrode LEa and a circular ring (annular) shaped electrode LEb. The electrode LEa is disposed inside the electrode LEb.

A wiring line WL1 is provided to overlap the circularly shaped electrode LEa. The wiring line WL1 is connected to the electrode LEa via a contact hole CH1. A wiring line WL2 is provided to overlap the circular ring shaped electrode LEb. The wiring line WL2 is connected to the electrode LEb via a contact hole CH2a and a contact hole CH2b. A combination of the electrode LEa and the electrode LEb forms an electrode pair LX. The area occupied by the electrode pair LX in plan view is equal to the area occupied by one lens forming area LFR. Note here that the number of electrodes LE (including the electrode LEa and the electrode LEb) is not limited to two described above.

Although not shown in the figure, the wiring line WL1 is provided between the base BA1 and the electrode LEa. The wiring line WL2 is provided between the base BAL and the electrode LEb. Insulating layers may be provided between the wiring line WL1 and the electrode LEa, and between the wiring line WL2 and the electrode LEb. The wiring lines WL (the wiring line WL1 and the wiring line WL2) and the electrodes LE (the electrode LEa and the electrode LEb) are connected via the contact hole CH1, the contact hole CH2a, and the contact hole CH2b formed in the insulating layer.

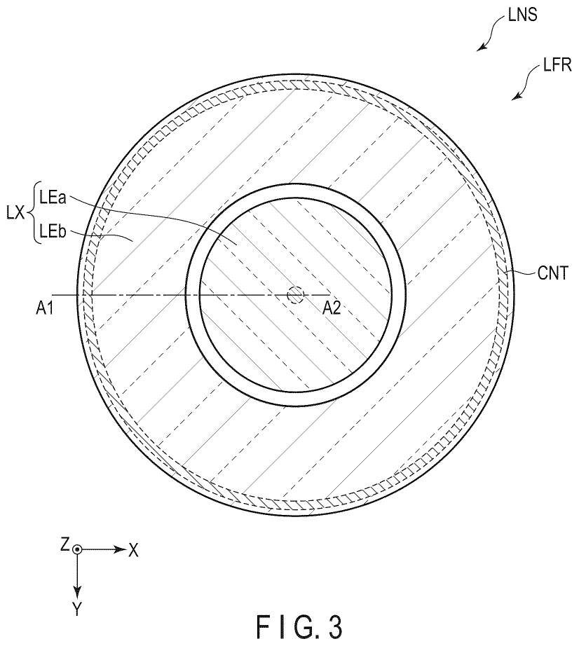

FIG. 3 is a plan view showing an example of the schematic configuration of the optical control element of the embodiment. A cross-sectional view taken along line A1-A2 in FIG. 3 is FIG. 1. As shown in FIG. 3, the circular ring shaped electrode LEb is provided on an outer side of the circularly shaped electrode LEa. In FIG. 3, the shaded area is the connection portion CNT of the high-resistance layer HRS. The connection portion CNT is formed into a circular ring shape.

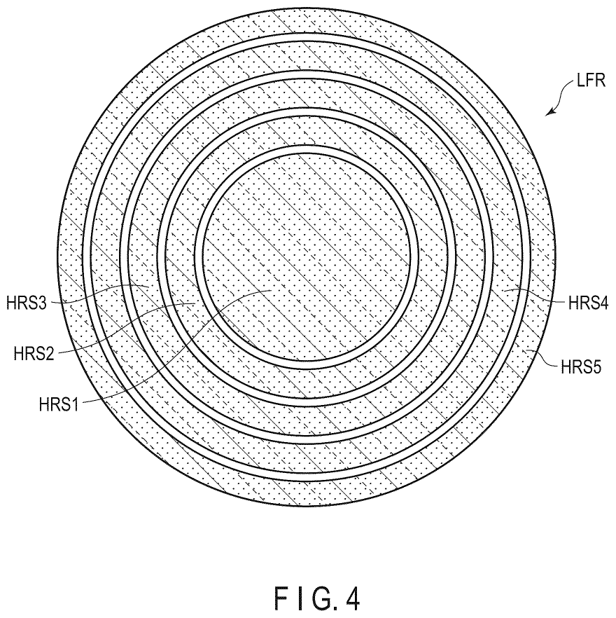

FIG. 4 is a plan view showing the shapes and arrangement of the high-resistance layers in the case of forming a Fresnel lens. The high-resistance layer HRS includes a plurality of high-resistance layers. In FIG. 4, the high-resistance layer HRS includes five high-resistance layers, a high-resistance layer HRS1, a high-resistance layer HRS2, a high-resistance layer HRS3, a high-resistance layer HRS4, and a high-resistance layer HRS5. Note that the number of high-resistance layers HRS is not limited to this, and any number of high-resistance layers can be provided.

The high resistance layer HRS1 has a circular shape. The high resistance layer HRS2, the high resistance layer HRS3, the high resistance layer HRS4, and the high resistance layer HRS5 are disposed concentrically at equal intervals with the circularly shaped high resistance layer HRS1 at the center.

The distance between the high resistance layer HRS1 and the high resistance layer HRS2, the distance between the high resistance layer HRS2 and the high resistance layer HRS3, the distance between the high resistance layer HRS3 and the high resistance layer HRS4, and the distance between the high resistance layer HRS4 and the high resistance layer HRS5 should preferably be as short as possible. The distance should be, for example, about 2 μm. The width of each of the high-resistance layer HRS2, the high-resistance layer HRS3, the high-resistance layer HRS4, and the high-resistance layer HRS5 should only be sufficient to deal with the phase change that the lens can be configured. Note that the number of circular ring shaped high-resistance layers is arbitrary and should be designed according to the lens power and the amount of phase change per circular ring shaped high-resistance layer.

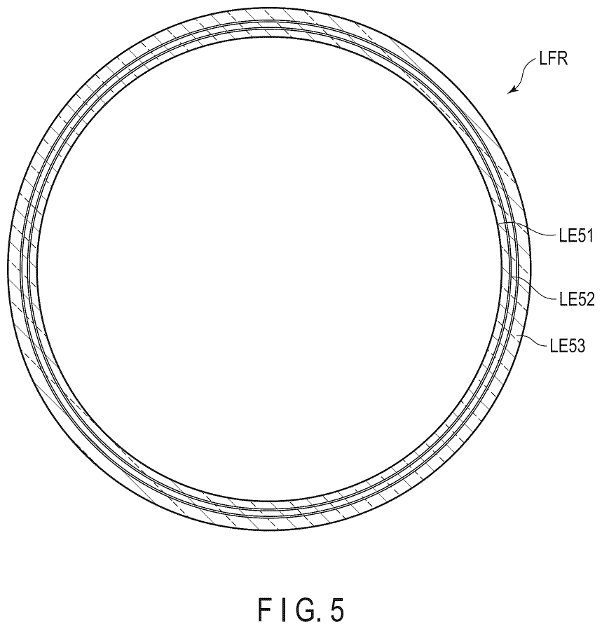

FIG. 5 is a plan view showing the shape and arrangement of the electrodes opposing the outermost high-resistance layer of the circular ring-shaped high-resistance layers shown in FIG. 4. FIG. 5 shows the electrodes LE opposing the high resistance layer HRS5 along the third direction Z among the high resistance layers HRS1 to HRS5 shown in FIG. 4.

Note that FIG. 5 illustrates only the electrodes LE and does not show the high-resistance layer HRS5. In FIG. 5, the area occupied by the electrode LE51, the electrode LE52, and the electrode LE53 is substantially the same as that of the high-resistance HRS5. That is, the electrode LE51, the electrode LE52, and the electrode LE53, and further the high-resistance HRS5 overlap each other in plan view.

The circular ring shaped electrode LE51, electrode LE52, and electrode LE53 are provided to face the high-resistance layer HRS5, which is not shown in the figure. Note that the number of electrodes is not limited to this, and two or less electrodes LE or four or more electrodes LE may be provided so as to oppose the high resistance layer HRS5.

The distance between the electrode LE51 and the electrode LE52 and the distance between the electrode LE52 and the electrode LE53 should preferably be as short as possible. The distances need not coincide with the distances between the plurality of high-resistance layers HRS, respectively, described above.

In FIG. 5, the electrodes LE opposing the high resistance layer HRS5 are discussed, but it is not limited to the high resistance layer HRS5. If suffices if a plurality of circular ring shaped electrodes LE are provided to oppose the other circular ring shaped high-resistance layer HRS2, high-resistance layer HRS3, and high-resistance layer HRS4, respectively. The electrodes LEs opposing the circularly shaped high-resistance layer HRS1 will be described in detail later.

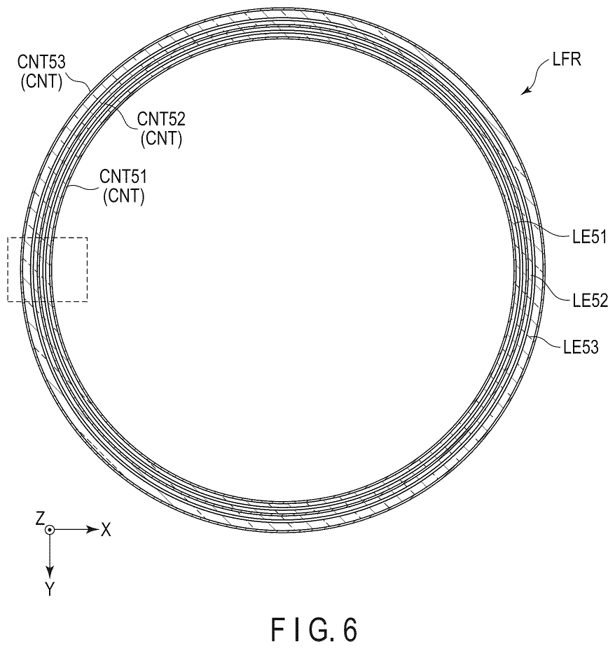

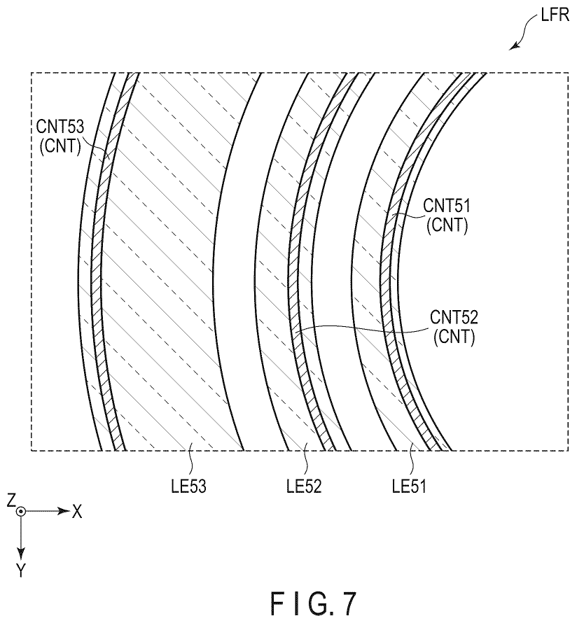

FIG. 6 is a plan view showing the shapes and arrangement of the connection portions provided respectively in the electrodes shown in FIG. 5. FIG. 7 is an enlarged view of the area enclosed by the dotted line in FIG. 6.

As shown in FIGS. 6 and 7, the connection portion CNT (shaded area) of the high-resistance layer HRS5 is provided in each of the electrode LE51, the electrode LE52, and the electrode LE53. The connection portions CNT corresponding respectively to the electrode LE51, the electrode LE52, and the electrode LE53 will be referred to as a connection portion CNT51, a connection portion CNT52, and a connection portion CNT53, respectively. The connection portions CNT (the connection portion CNT51, connection portion CNT52, and connection portion CNT53) are formed into a circular ring shape. The width of each of the connection portion CNT51, the connection portion CNT52, and the connection portion CNT53 is smaller than the width of the electrodes LE (the electrode LE51, electrode LE52, and electrode LE53) provided therefor.

The width of each of the electrode LE51, the electrode LE52, and the electrode LE53 can be adjusted accordingly to the width optimal for creating a phase difference distribution, as needed.

In two or more electrodes LE (in FIG. 5, the electrode LE51, the electrode LE52, and the electrode LE53 opposing the high-resistance layer HRS5) are provided so as to oppose one high resistance layer HRS (each of the high-resistance layer HRS1, the high-resistance layer HRS2, the high-resistance layer HRS3, the high-resistance layer HRS4, and the high-resistance layer HRS5 in FIG. 4). Note that further more electrodes may be provided.

The innermost electrode LE and the high-resistance layer HRS are connected to each other at the innermost side, and the outermost electrode LE and the high-resistance layer HRS are connected at the outermost side. The connection sites of other electrodes LE and high-resistance layers HRS can be provided in any way as needed.

For example, of the electrode LE51, the electrode LE52, and the electrode LE53, the connection portion CNT51 in contact with the electrode LE51 is located closer to the center of the lens forming area LFR, in other words, on a more inner side. Of the electrode LE51, the electrode LE52, and the electrode LE53, the connection portion CNT53 in contact with the electrode LE53 is located farther from the center of the lens forming region LFR, in other words, on a more outer side. That is, the connection portion CNT51 in contact with the electrode LE51 is located on a more inner side with respect to the area occupied by the electrode LE51, and the connection portion CNT53 in contact with the electrode LE53 is located on a more outer side with respect to the area occupied by the electrode LE53.

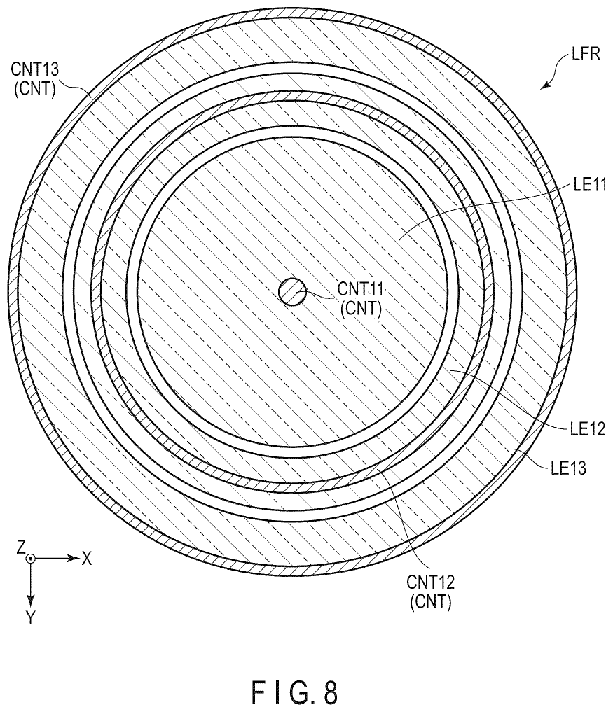

FIG. 8 is a plan view of the shapes and arrangement of the electrodes opposing the innermost high-resistance layer of the circular ring shaped high-resistance layer shown in FIG. 4. FIG. 8 shows the electrode LE opposing the high-resistance layer HRS1 along the third direction Z among the high-resistance layer HRS1 to high-resistance layer HRS5 shown in FIG. 4.

Note that FIG. 8 shows only the electrodes LE and does not show the high resistance layer HRS1. In FIG. 8, the area occupied by the electrode LE11, the electrode LE12, and the electrode LE13 is substantially the same as that of the high-resistance HRS1. That is, the electrode LE11, the electrode LE12, and the electrode LE13, and further the high-resistance HRS1 overlap each other in plan view.

The circularly shaped electrode LE11, circular ring shaped electrode LE12, and circular ring shaped electrode LE13 are provided to oppose the high-resistance layer HRS1, which is not shown in the figure. Note that the number of electrodes is not limited to this, but two or less electrodes LE or four or more electrodes LE may be provided to oppose the high-resistance layer HRS1.

The distance between the electrode LE11 and the electrode LE12 and the distance between the electrode LE12 and the electrode LE13 should preferably be as short as possible. The distances need not coincide with the distances between the plurality of high-resistance layers HRS, respectively, described above.

As shown in FIG. 8, the connection portion CNT11 (shaded area) of the high-resistance layer HRS1 is provided to be in contact with the electrode LE11, and the connection portion CNT12 and the connection portion CNT13 (shaded area) of the high-resistance layer HRS1 are provided to be in contact with the electrode LE12 and the electrode LE13 respectively. The connection portion CNT11 in contact with the electrode LE11 is formed into a circularly shape, and the connection portion CNT12 and the connection portion CNT13 in contact with the electrode LE12 and the electrode LE13, respectively, are formed into respective circular ring shapes. The diameter of the circularly shaped connection portion CNT11 in contact with the electrode LE11 is smaller than the diameter of the electrode LE11. The width of each of the circular ring shaped CNT12 and connection portion CNT13 in contact with the electrode LE12 and the electrode LE13, respectively, is smaller than the width of the electrodes LE provided therefor.

The width of each of the electrode LE11, the electrode LE12, and the electrode LE13 can be adjusted accordingly to the width optimal for creating a phase difference distribution as needed.

In FIG. 8, two or more electrodes LE (electrode LE11, electrode LE12, and electrode LE13) are provided to oppose one high-resistance layer HRS1 (not shown), but a further more electrodes may be provided.

In FIG. 8, the innermost electrode LE and the high-resistance layer HRS are connected to each other at the innermost side, and the outermost electrode LE and the high-resistance layer HRS are connected each other at the outermost side. The connection sites of the other electrodes LE and high-resistance layer HRS can be provided in any way as needed.

For example, among the electrode LE11, electrode LE12, and electrode LE13, the connection portion CNT11 in contact with the electrode LE11 is located closer to the center of the lens forming area LFR, in other words, on a more inner side. Among the electrode LE11, the electrode LE12, and the electrode LE13, the connection portion CNT13 in contact with the electrode LE13 is located farther from the center of the lens forming region LFR, in other words, on a more outer side. That is, the connection portion CNT11 in contact with the electrode LE11 is disposed on an inner side (center) with respect to the area occupied by the electrode LE11, and the connection portion CNT13 in contact with the electrode LE13 is disposed on an outer side with respect to the area occupied by the electrode LE13.

Here, as a comparative example 1, let us consider an example in which the electrode LEa and electrode LEb are in contact with the high-resistance layer HRS, but do not substantially overlap the high-resistance layer HRS in plan view. Further, as a comparative example 2, consider an example in which the electrode LEa and the electrode LEb overlap the high-resistance layer HRS in plan view, but are not brought into contact with the high-resistance layer HRS.

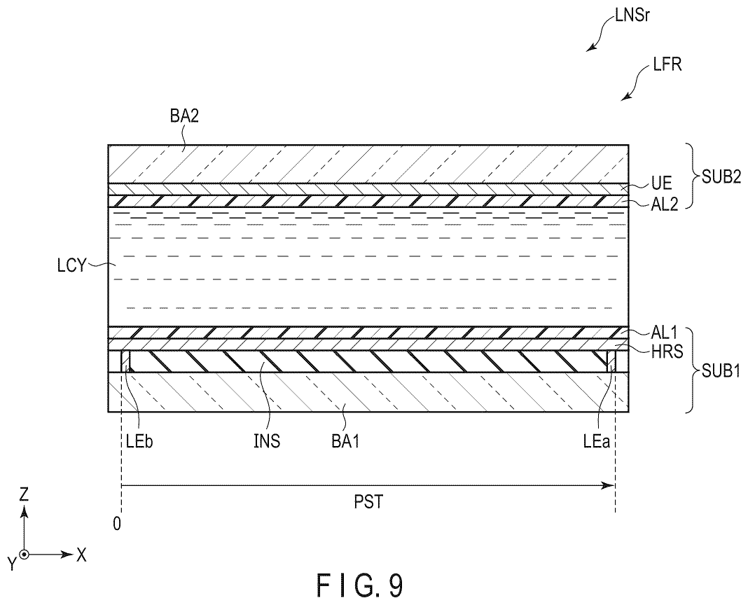

FIG. 9 shows a cross-sectional view showing an optical control element of the comparative example 1. In an optical control element LNSr shown in FIG. 9, the area where the electrode LEa and the electrode LEb overlap the high-resistance layer HRS is extremely small. Since the area in plan view occupied by the electrode LEa and electrode LEb is small, it can be said that the electrode LEa and the electrode LEb shown in FIG. 9 do not substantially overlap the high-resistance layer HRS.

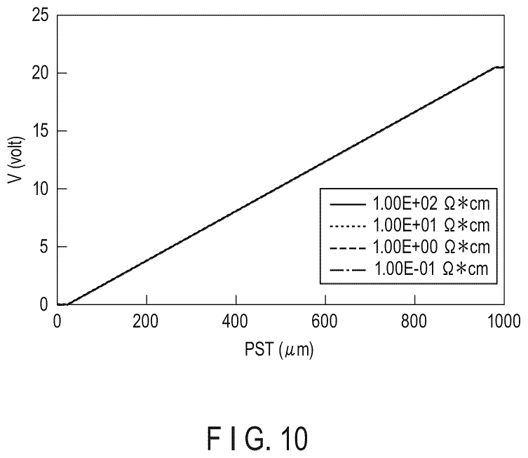

FIG. 10 is a diagram showing the relationship between the distance between the electrodes and voltage in the optical control element shown in FIG. 9. In FIG. 10, the horizontal axis indicates the distance PST to the electrode LEa when the position of the electrode LEb is set to 0. The vertical axis indicates the applied voltage V.

FIG. 10 shows plotting for the high-resistance layer HRS with various resistances. The resistances of the high-resistance layer HRS are 1.00E+02 (1.00× 10²) [Ω*cm], 1.00E+01 (1.00× 10¹ [Ω*cm], 1.00E+00 (1.00) [Ω*cm], and 1.00E-01 (1.00×10⁻¹) [Ω*cm].

As shown in FIG. 10, even when the resistance of the high-resistance layer HRS is varied, the relationship between the distance PST of the electrodes LEa and LEb and the voltage V does not vary. The voltage V is linearly distributed with respect to the distance PST between the electrode LEa and the electrodes LEb.

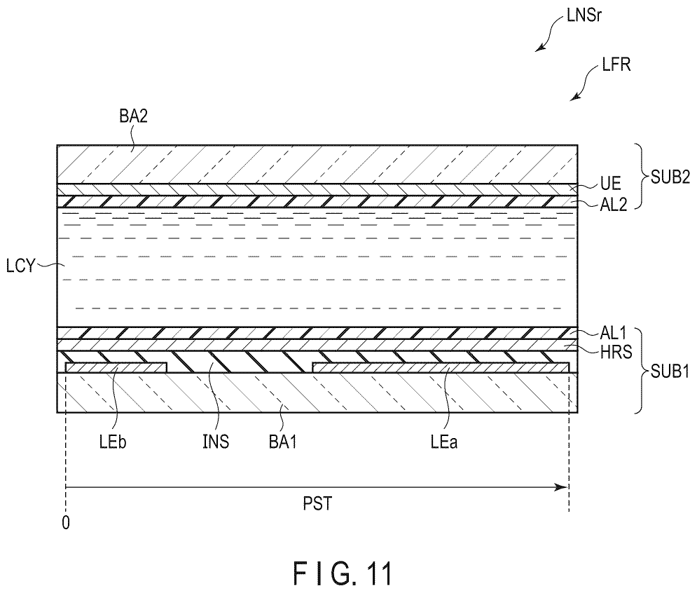

FIG. 11 is a cross-sectional view of the optical control element of the comparative example 2. In the optical control element LNSr shown in FIG. 11, the electrode LEa and the electrode LEb are not in contact with the high-resistance layer HRS, as described above, and are separated from each other.

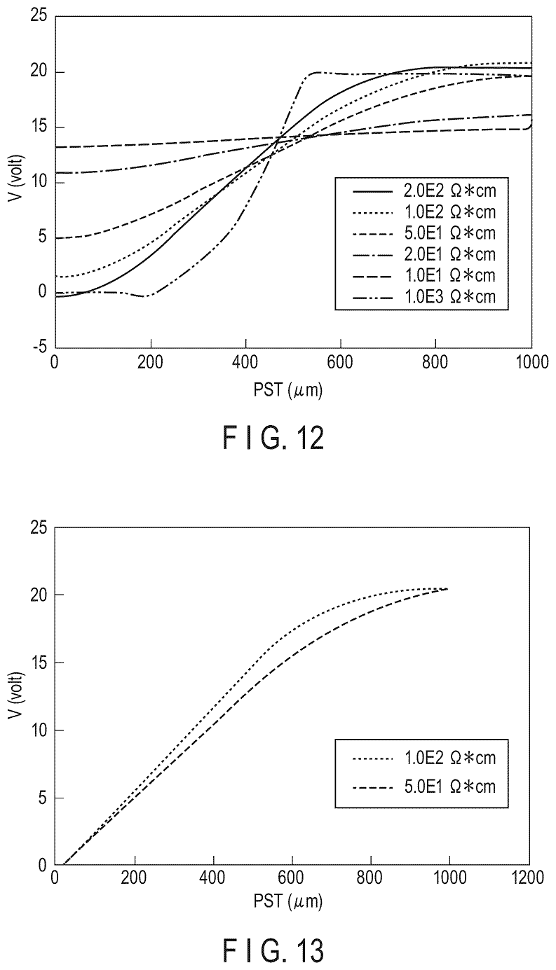

FIG. 12 is a diagram showing the relationship between the distance between the electrodes and the voltage in the optical control element shown in FIG. 11. In FIG. 12, the horizontal axis indicates the distance PST to the end portion of the electrode LEa when the position of the electrode LEb is set to 0. The vertical axis indicates the applied voltage V.

FIG. 12 shows plotting for the high-resistance layer HRS with various resistances. The resistances of the high-resistance layer HRS are 1.0E+03 (1.00×10³) [Ω*cm], 2.0E+02 (2.0×10²) [Ω*cm], 1.0E+02 (1.0×10²) [Ω*cm], 5.0E+01 (5.0×10¹) [Ω*cm], 2.0E+01 (2.0×10¹) [Ω*cm], and 1.0E+01 (1.0×10¹) [Ω*cm].

As shown in FIG. 12, the voltage Vis nonlinearly distributed with respect to the distance PST between the electrode LEa and the electrode LEb. Even when the resistance of the high-resistance layer HRS is varied, the voltage distribution varies accordingly.

In the comparative example 1, the voltage Vis linearly distributed with respect to the distance PST. Even when the resistance of the high-resistance layer HRS is varied, the linear distribution of the voltage V does not vary (see FIGS. 9 and 10). Therefore, a large number of high-resistance layers are required when a desired linear distribution of voltage cannot be obtained.

In the comparative example 2, the voltage V is nonlinearly distributed with respect to the distance PST. Since the distribution of the voltage V varies extremely due to fluctuations in the resistance of the high-resistance layer HRS (see FIGS. 11 and 12), there may be a defect that the process margin is narrow.

FIG. 13 is a diagram showing the relationship between the distance between electrodes and voltage in the optical control element of the embodiment. In FIG. 13, the horizontal axis indicates the distance PST to the connection portion CNT of the electrode LEa when the position of the connection portion CNT of the electrode Leb is set to 0 (see FIG. 1 as well). The vertical axis indicates the applied voltage V.

In FIG. 13, the resistances of the high-resistance layer HRS are 5.0E+01 (5.0×10¹) [Ω*cm] and 1.0E+02 (1.0×10²) [Ω*cm]. Further, voltages of 0V, 15V, and 0V are applied to the electrode LEb, electrode LEa, and electrode UE, respectively.

As shown in FIG. 13, a similar trend is obtained, in which even when the resistance of the high-resistance layer HRS varies, the distribution of the voltage V increases as the distance PST increases. With this configuration, even when the resistance of the high-resistance layer HRS varies due to variations in manufacturing, it is possible to obtain a voltage distribution with a similar trend.

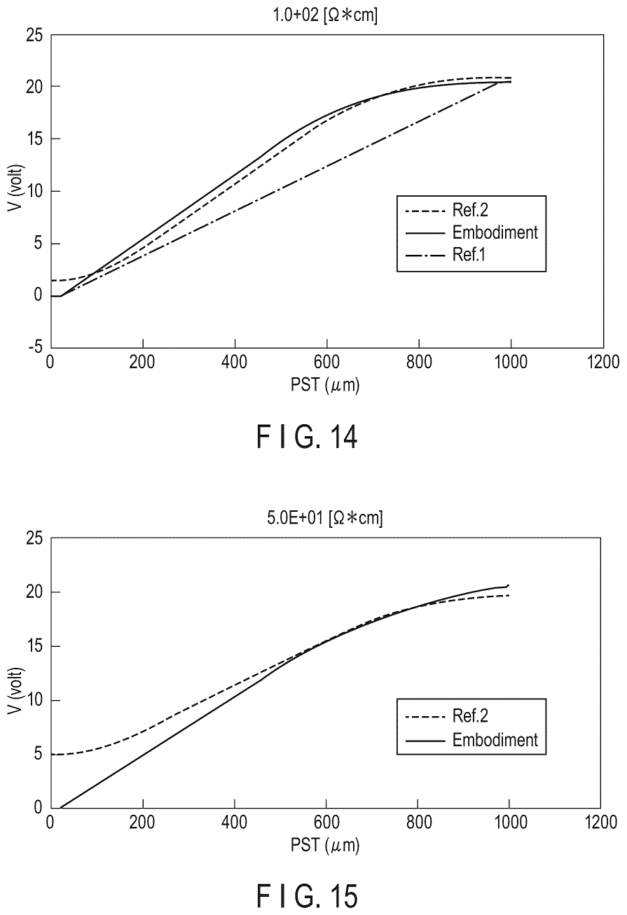

FIG. 14 is a diagram showing the distributions of voltage in the comparative example 1, the comparative example 2, and the embodiment when these cases have the same resistance of the high-resistance layer. In FIG. 14, the resistance of the high-resistance layer HRS is 1.0E+02 (1.0×10²) [Ω*cm]. The cross sections of the optical control elements of the comparative example 1, comparative example 2, and the embodiment are as shown in FIGS. 9, 11, and 1, respectively.

As shown in FIG. 14, in the optical control element LNS of the embodiment, the distribution of the voltage V with respect to the distance PST is nonlinear, as in the case of the comparative example 2. On the other hand, the distribution of the voltage V in the comparative example 1 is linear, which is different from the voltage distribution of the embodiment.

FIG. 15 is a diagram showing the distributions of the voltage of the comparative example 2 and the embodiment when they have the same resistance of the high-resistance layer. In FIG. 15, the resistance of the high-resistance layer HRS is 5.0E+01 (5.0×10¹) [Ω*cm], which is smaller than that shown in FIG. 14. The cross sections of the optical control elements in the comparative example 2 and the embodiment are as shown in FIGS. 11 and 1, respectively.

As shown in FIG. 15, the voltage V with respect to the distance PST in the comparative example 2 takes a constant value as when the distance PST becomes small. When the resistance of the high-resistance layer HRS becomes small, there may be a defect that the voltage V will not vary when the distance PST is small.

On the other hand, in the optical control element LNS of the embodiment, even when the resistance of the high-resistance layer HRS becomes small and the distance PST is small, the voltage V varies with respect to the distance PST.

In the optical control element LNS of the embodiment, the voltage V with respect to the distance PST between the electrode LEb and the electrode LEa shows a nonlinear distribution. Further, even when the resistance of the high-resistance layer HRS is varied, the voltage V exhibits a similar behavior. With this configuration, it is possible to obtain a liquid crystal lens with improved quality.

The optical control element LNS of the embodiment is a liquid crystal lens as described above. By combining the liquid crystal lens with a display panel, for example, a liquid crystal display panel, it is possible to realize a display device which can adjust the light emitted from the pixels of the display panel.

The optical control element LNS of the embodiment can adjust the angle of light incident on the optical control element LNS and emit the light. Therefore, the optical control element LNS can as well function as a view angle control element or a diffraction grating.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical control element comprising:
a base;
an electrode provided on the base;
a liquid crystal layer provided on the electrode; and
a high-resistance layer having a resistance higher than that of the electrode and provided between the electrode and the liquid crystal layer, wherein
the electrode overlaps the high-resistance layer in plan view, and
a connection portion of the high resistance layer is in contact with the electrode.

2. The optical control element according to claim 1, wherein
the electrode includes at least a first electrode and a second electrode,
the second electrode has a circular ring shape, and
the first electrode has a circular shape and is provided on an inner side with respect to the second electrode.

3. The optical control element according to claim 1, further comprising:
an insulating layer provided between the electrode and the high resistance layer, wherein
the connection portion of the high-resistance layer is brought into contact with the electrode via a contact hole formed in the insulating layer.

4. The optical control element according to claim 1, wherein
the electrode includes at least a first electrode and a second electrode, and
the optical control element is a liquid crystal lens that modulates the liquid crystal layer based on a distribution of voltages applied to the first electrode and the second electrode.

5. The optical control element according to claim 1, wherein
the high-resistance layer includes a plurality of high resistance layers, and
the electrode includes a plurality of electrodes opposing of the plurality of high-resistance layers, respectively.

6. The optical control element according to claim 1, further comprising:
a first substrate including the base, the electrode, the high-resistivity layer, and a first alignment film;
a second substrate comprising a third electrode and a second alignment film, wherein
the liquid crystal layer is interposed between the first substrate and the second substrate.
